(19) United States
(12) Patent Application Publication
(10) Pub. No.: US 2025/0348517 A1
(43) Pub. Date: Nov. 13, 2025

(54) Dynamic Cached Point of Interest Object Databases with Content Based on Mobile Device Location and/or User Interests

(71) Applicant: Yellcast, Inc., San Carlos, CA (US)

(72) Inventor: Thomas William Ellenby, Wembley (GB)

(21) Appl. No.: 19/274,149

(22) Filed: Jul. 18, 2025

Related U.S. Application Data
(63) Continuation-in-part of application No. 19/072,812, filed on Mar. 6, 2025.
(60) Provisional application No. 63/562,177, filed on Mar. 6, 2024.

(51) Int. Cl. G06F 16/29; G06F 16/22

(52) U.S. Cl. CPC G06F 16/29; G06F 16/2272

(57) ABSTRACT

A local object database is populated from a geospatial indexing system database. An object has a geolocation representing one or more locations relative to points and/or regions relative to a geographic range of object records. A method might comprise determining a device geolocation state of the mobile device, determining a first geographical search space as a function of device geolocation and area relative to the device geolocation, querying the geospatial indexing system database for a localized subset of object records with geolocations within the first geographical search area, populating the local database with the search results, determining whether the results comprise filterable object records that include a filter parameter, comparing the filter parameter and device geolocation state. When a filterable object record is present in the results and a filter parameter does not match the device geolocation state, the filterable object record is filtered from the local database.

### CROSS-REFERENCES TO PRIORITY AND RELATED APPLICATIONS

This application is a continuation-in-part of application Ser. No. 19/072,812 filed Mar. 6, 2025, entitled “Dynamic Locally Cached Point of Interest Object Databases with Content Based on Mobile Device Location and/or User Interests,” which claims priority from and is a non-provisional of U.S. Provisional Patent Application No. 63/562, 177, filed Mar. 6, 2024, entitled “Dynamic Locally Cached Point of Interest Object Databases with Content Based on Mobile Device Location and/or User Interests.”

The entire disclosure(s) of application(s)/patent(s) recited above is (are) hereby incorporated by reference, as if set forth in full in this document, for all purposes.

### FIELD

The present disclosure generally relates to providing object records to users of mobile devices and more particularly to selectively providing object records based on mobile device location and/or user interests.

### BACKGROUND

There arises a need for smart data management for users of mobile devices to prevent them from becoming overloaded with object records and related data that may be irrelevant to the user based on their current location and defined interests.

### BRIEF DESCRIPTION OF THE DRAWINGS

Various embodiments in accordance with the present disclosure will be described with reference to the drawings, in which:

FIGS. 1A and 1B are a flowchart illustrating a possible mode of operation of the system associated with access range.

FIG. 2 is a diagram in plan view illustrating an example of a possible mode of operation of the system associated with access range.

FIGS. 3A and 3B are a flowchart illustrating a possible mode of operation of the system associated with access range.

FIG. 4 is a diagram in plan view illustrating an example of a possible mode of operation of the system associated with access range.

FIGS. 5A and 5B are a flowchart illustrating a possible mode of operation of the system associated with the location of a mobile device in relation to various geographically defined areas.

FIG. 6 is a diagram in plan view illustrating an example of a possible mode of operation of the system associated with the location of a mobile device in relation to various geographically defined areas.

FIG. 7 is a flowchart illustrating a possible mode of operation of the system associated with access range.

FIG. 8 is a flowchart illustrating a possible mode of operation of the system associated with the location of a mobile device in relation to various geographically-defined areas.

FIG. 9 illustrates an example computer system memory structure as might be used in performing methods described herein, according to various embodiments.

FIG. 10 is a block diagram illustrating an example computer system upon which the systems illustrated in FIGS. 1-7 may be implemented, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Using the methods and system described herein, the response time of geographical searches based upon location of a mobile device might be improved, limited off grid access to geolocated information with a mobile device might be implemented, and reduction of geo-clutter or geo-spam might be the case.

A geospatial indexing system is a data structure that organizes geospatial data (like points, lines, and polygons) in a way that allows for fast and efficient retrieval of information based on location or geospatial relationships. It's essentially a method of organizing geographic data to enable quick searches and analysis of geographically relevant information within a database or other system. An example of such a geospatial indexing system would be H3 which is a geospatial indexing system that partitions the world into hexagonal cells. Such a hexagonal geospatial indexing system will be used to illustrate possible modes of operation of the invention. It should be noted that while a hexagonal geospatial indexing system is being used to illustrate possible modes of operation of the invention other geospatial indexing systems utilizing various other polygons, shapes, areas, etc. may be used and no limitation is intended.

Also, individual units of a geospatial indexing system may be referred to as a cell or cells, an element or elements, etc. Such terms may be used interchangeably and no limitation is intended with the use of or the exclusion of any such term.

It should also be noted that while geospatial indexing systems such as H3 may have elements of many sizes nested within each other, the methods described herein can be scale agnostic. In the case of H3, the scale of a cell ranges from H0 with an average area of 4,357,449.416078381 km² to H15 with an average area of 8.95×10⁷ km². The scales might be applicable regardless of the specific size of the individual elements of the geospatial indexing system being used by the system.

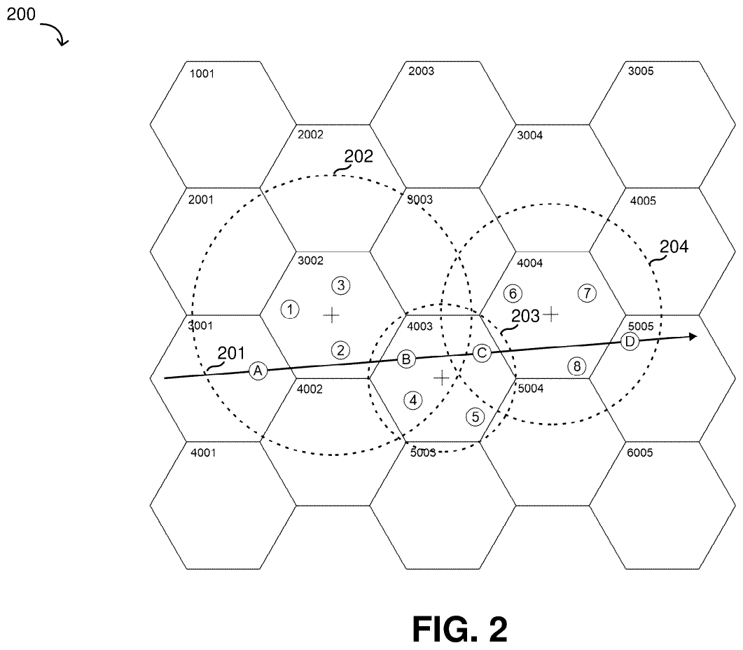

It should also be noted that while FIGS. 2, 4, and 6 and related flowcharts and text for simplicity of explanation illustrate possible modes of operation of the invention in plan view (in two dimensions from “above”), the same possible modes of operation would be equally applicable within a three-dimensional geospatial indexing system comprising, for example, three-dimensional slices of columns based upon elements of a two dimension geospatial indexing system or a three dimensional geospatial indexing system based upon three-dimensional dodecahedral (i.e., 12-sided) elements, or other three-dimensional elements.

A system described herein might comprise one or more servers that are connected over a network with one or more mobile client devices. The system can process localized geolocation information pertaining to objects, either real world or virtual, that have a real-world position.

The objects could be natural features, such as mountains, river deltas, trailheads, locations on a feature such as a river that spans a large distance, etc. The objects could be human-made, such as buildings, monuments, plantings, vistas, shops, cultural points of interest, etc. The objects need not have a physical presence involving matter, such as a point 30 meters due west of the intersection of the intersection of Elm Street and Broadway Boulevard where a particular club meets for bird watching.

A data structure describing such an object might comprise fields for describing the object, assigning it to a particular category or class of objects, fields for images depicting the object and/or its environs, and fields indicating its location and/or a particular point of its location (e.g., a large object like an arena can have its location be its geographic center or a point just outside its public entrance. Such a data structure might be represented in computer memory as a point of interest object record. A point of interest object record database might comprise a collection of object records.

A user of a mobile device might take steps to include a local object record database on the mobile device. Individual object records might be added and subtracted from a user's local object record database on their mobile device or alternatively cache the local object record database remotely from the mobile device. Individual object records may be added and subtracted from a local object record database based on their proximity to each object and also dependent on the user's preferences. The system might maintain the local object record database by caching object records from a remote general database such that object records that are deemed close to the user's mobile device and delete object records from the local object record database once the system determines that they no longer meet a proximity requirement.

The system might deem an object record to represent an object that is close to the user's mobile device, or deem it not close, based on some proximity requirement determined by a proximity test. In this manner, the system can maintain a local cloud of object records and related information. The proximity requirement might relate to the distance between the mobile device's determined location (which might or might not be its actual current location) and the indicated location indicated in the location field or fields of the object's object record. The proximity requirement might be implemented by, or represented by, a filter parameter or a plurality of filter parameters.

Object records might be added to the object record database either locally cached on the mobile device or cached remotely (cloud storage, etc.) as the determined range to the location associated with the element of the geospatial indexing system that the object record is associated with is less than an access range associated with that element of the geospatial indexing system or alternatively the determined location of the mobile device is within a geographical access area associated with the element of the geospatial indexing system. These object records are then available to be searched but they are not instantly displayed like spam. This technology would be applicable to GPS-only devices or devices capable of pointing, casting, and/or visual augmented reality.

In addition to objects already known and stored as part of an object record database there are also an increasing number of objects that are transmitting their location and information about where and what they are via RFID, Bluetooth, and other transmission methods, such as the

Internet of Things (“IoT”). Databases of geolocated objects might comprise records for objects such as restaurants, bars, shops, gas stations etc. An IoT database might contain records for smaller localized static and dynamic geolocated objects such as ATMs, vending machines, store displays, etc., mobile objects such as food trucks or street vendors, and city assets such as street lighting, etc. These IoT objects and related information might also be cached on a user's mobile device and added and subtracted from the locally cached database by comparing the determined range from the location of the mobile device to the location of the IoT object and any related access range threshold.

Access range thresholds or geographical access areas associated with object records need not be static and they may be dynamic and responsive to time of day, local weather, time of year, etc.

An example of a Point of Interest object record (“object record”) might be a data structure that contains stored attributes and information that identify a specific geo-coded object (either real or virtual), which is sometimes referred to as a geolocated Point of Interest (“object record”). In a particular embodiment, the attributes and information might comprise at least:
(a) ID: A unique identifier of the object, e.g., “object 200967”.
(b) Location: A specific location in 3-space in relation to a local coordinate system being used, e.g., latitude, longitude, and altitude, of the primary point reference of the object. The primary point reference of an object might be a center of the object, a point in relation to a feature of the object, such as the public entrance to a building, or some venue-designated point.
(c) Shape/size and orientation: A geometric description of the shape and size of the object, the location of the primary point reference within this geometric description, and the geometric description's orientation to the local coordinate system being used. The shape and/or size of the object can be zero, e.g., a simple point, two-dimensional, e.g., a line segment, or three-dimensional. Examples may be a sphere of a defined radius centered on a primary point reference of the object, or a more complex 3D geometric shape/model located and oriented in relation to the primary point reference and the local coordinate system.
(d) Type: A category of objects the object belongs in. Possible categories may include History, Tourism, Restaurants, Transit, etc. The categories can be variable depending on the application. It should be appreciated that an object could be defined as belonging to two or more categories.
(e) Related Information: The information related to a specific geo-located object such as graphics, audio, etc. This related information may also be a link to a location where such information may be stored remotely.
(f) Access range (if applicable): A range at which the object record of the object will become accessible. Accessibility may trigger the object being added to the cached local object record database.
(g) Geographical access area (if applicable): The geographical area associated with the location of the object record. If a mobile device is determined to be within this geographical area, the object record will become accessible and may be added to the cached local object record database.

For the following examples, the object record database is cached on the mobile device itself, but in alternate embodiments of the invention, the object record database may be cached remotely from the mobile device via cloud storage, etc. No restriction regarding the location of the cached object record database is intended or claimed.

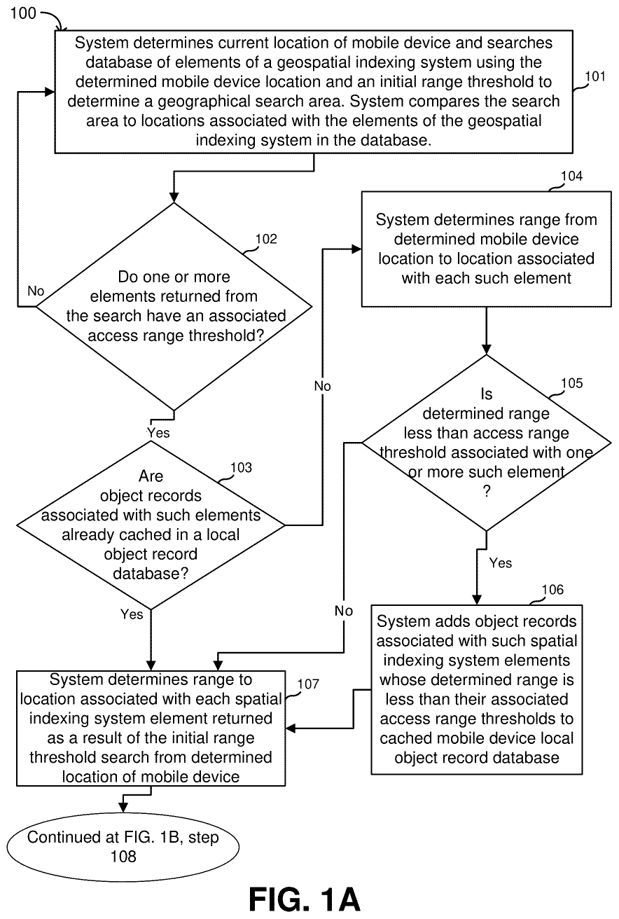

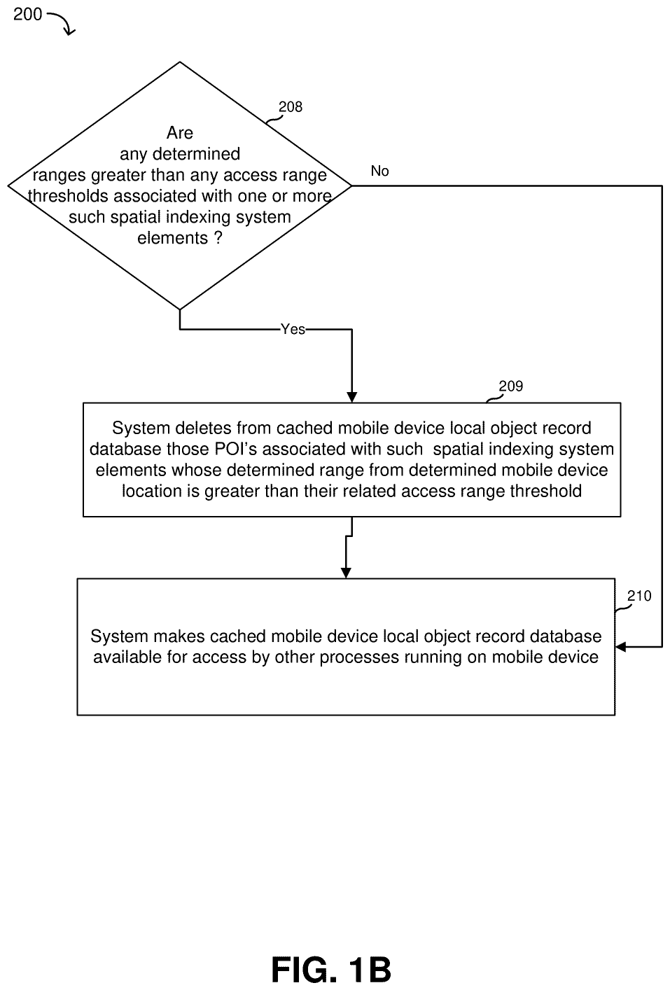

FIGS. 1A and 1B are a flowchart 100 illustrating a possible mode of operation of the system in relation to individual elements of a geospatial indexing system with associated access ranges. The system might be a client device or other device mentioned herein. The location associated with the access range threshold for each element is shown as at the center of each element, but this need not be true in all instances, and this example is non-limiting. In step 101, the system determines the location of the mobile device and searches a database of elements of a geospatial indexing system using the determined location of the mobile device and an initial, pre-determined, range threshold to determine a geographical search area and further determines those elements of the geospatial indexing system that are encompassed by the geographical search area. It should be noted that the term “encompassed by the geographical search area” may be taken to mean but is not limited to the entire geographical area defined by an individual element being encompassed by the search area, a portion of the geographical area defined by an individual element being encompassed by the search area, or a geographical location associated with that element being encompassed by the search area. This search using an initial range threshold will limit the number of elements to be considered by the system for future interrogation. For example, the initial range threshold may be 500 m which would, if the scale of each element of a hexagonal geospatial indexing system were hexagons 10 m across, yield a result of approximately 750 elements available for future interrogation by the system. The flowchart then branches to step 102. In step 102, the system determines if one or more elements of the geospatial indexing system returned as a result in the search performed in step 101 has an associated access range threshold. If the system determines that one or more elements of the geospatial indexing system returned as a result in the search performed in step 101 does not have an associated access range threshold, the flowchart branches to step 101 to repeat the process. If the system determines that one or more elements of the geospatial indexing system returned as a result in the search performed in step 101 has an associated access range threshold, the flowchart branches to step 103. In step 103, the system determines if object records associated with those elements of the geospatial indexing system with related access range thresholds are already cached in the local object record database. If the system determines that those object records associated with those elements of the geospatial indexing system with related with related access range thresholds are already cached in the local object record database, the flowchart then branches to step 107. If the system determines that those object records associated with those elements of the geospatial indexing system with related access range thresholds are not already cached in the local object record database, the flowchart then branches to step 104.

In step 104, the system determines a range from the determined mobile device position to the location associated with each such element of the geospatial indexing system. The flowchart then branches to step 105. In step 105, the system determines if the determined range to the location associated with one or more such elements of the geospatial indexing system is less than the access range threshold associated with that element of the geospatial indexing system. If the determined range to the location associated with one or more such elements of the geospatial indexing system is not less than the access range threshold associated with that element of the geospatial indexing system, the flowchart then branches to step 107. If the determined range to the location associated with one or more such elements of the geospatial indexing system is less than the access range threshold associated with that element of the geospatial indexing system, the flowchart then branches to step 106.

In step 106, the system adds those object records associated with elements of the geospatial indexing system whose determined range is less than its associated access range threshold to the system's local object record database cached on the mobile device. The flowchart then branches to step 107. In step 107, the system determines the range from the determined location of the mobile device to the location-associated elements of the geospatial indexing system with object records cached in the system's local object record database. The flowchart then branches to FIG. 1B, step 108. In step 108, the system determines if any ranges, as determined in step 107, are greater than the access range thresholds associated with elements of the geospatial indexing system associated with each specific object record in the system's local object record database. If any such ranges are not greater than the access range thresholds associated with elements of the geospatial indexing system associated with each specific object record in the system's local object record database then the flowchart branches to step 110. If any such ranges are greater than the associated access range thresholds elements of the geospatial indexing system associated with each specific object record in the system's local object record database, then the flowchart branches to step 109.

In step 109, the system deletes from the system's local object record database those object records associated with those elements of the geospatial indexing system whose determined range from the determined location of the mobile device is greater than their associated range thresholds. The flowchart then branches to step 110. In step 110, the system makes the system's local object record database available to other processes, such as location-based search, augmented reality or pointing search, running on the mobile device. The flowchart then branches back to FIG. 1A and step 101 to continue the filtering process for the system's cached local object record database.

FIG. 2 is a diagram 200 illustrating, in plan view, an example of a possible mode of operation of the system associated with access range as described in FIG. 1 and related text.

This example is simplified in that the initial range threshold used to define the search area in relation to the determined position of the mobile device encompasses all object records (1-8) present in this example. A mobile device is moving along a route 201 and is continually filtering its local cached object record database according to the method described in FIG. 1 and related text. While the route of travel taken by the mobile device is shown as a straight line for simplicity of explanation it should be appreciated that a non-linear route of travel is also possible with no alteration to underlying method.

In this example, there are three elements of the geospatial indexing system, element 3002, element 4003 and element 4004, with an associated access range threshold, 202, 203, and 204, respectively. At determined location A the mobile device is within the access range threshold 202 associated with element 3002 and hence adds object records 1, 2 & 3 which are associated with element 3002 to the cached local object record Geodescriptor database. At determined location B the mobile device remains within the access range threshold 202 associated with element 3002 and is also within the access range threshold 203 associated with element 4003.

Hence the system adds object records 4 & 5 which are associated with element 4003 to the cached local object record Geodescriptor database. At determined location C the mobile device remains within the access range 203 associated with element 4003, is also within the access range threshold 204 associated with element 4004, and is no longer within the access range 202 associated with element 3002. Hence the system adds object records 6, 7 & 8 which are associated with element 4004 to the cached local object record Geodescriptor database and deletes object records 1, 2 & 3 which are associated with element 3002 from the cached local object record Geodescriptor database. At determined location D the mobile device remains within the access range threshold 204 associated with element 4004 h3 and is no longer within the access range threshold of element 4003. Hence object records 4 & 5 which are associated with element 4003 are deleted from the cached local object record Geodescriptor database. For this example, the local cached database of object records s would be as follows for each discrete mobile device location;

| | Object Records in Mobile Device |
|---|---|
| Mobile Device Location | Cached Object Record Database |
| A | 1, 2, 3 |
| B | 1, 2, 3, 4, 5 |
| C | 4, 5, 6, 7, 8 |
| D | 6, 7, 8 |

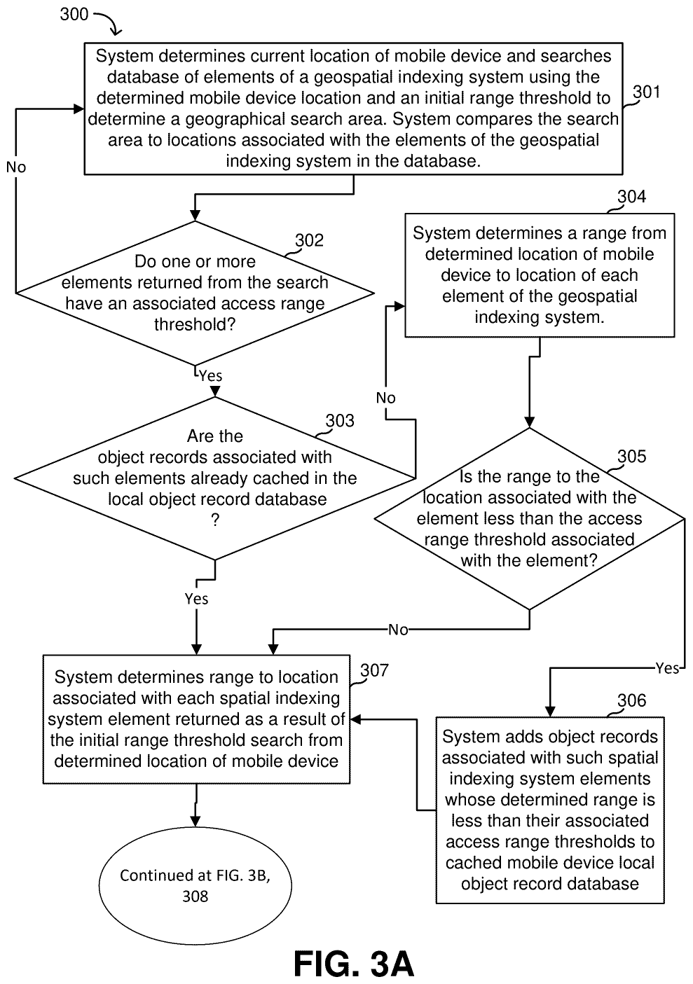

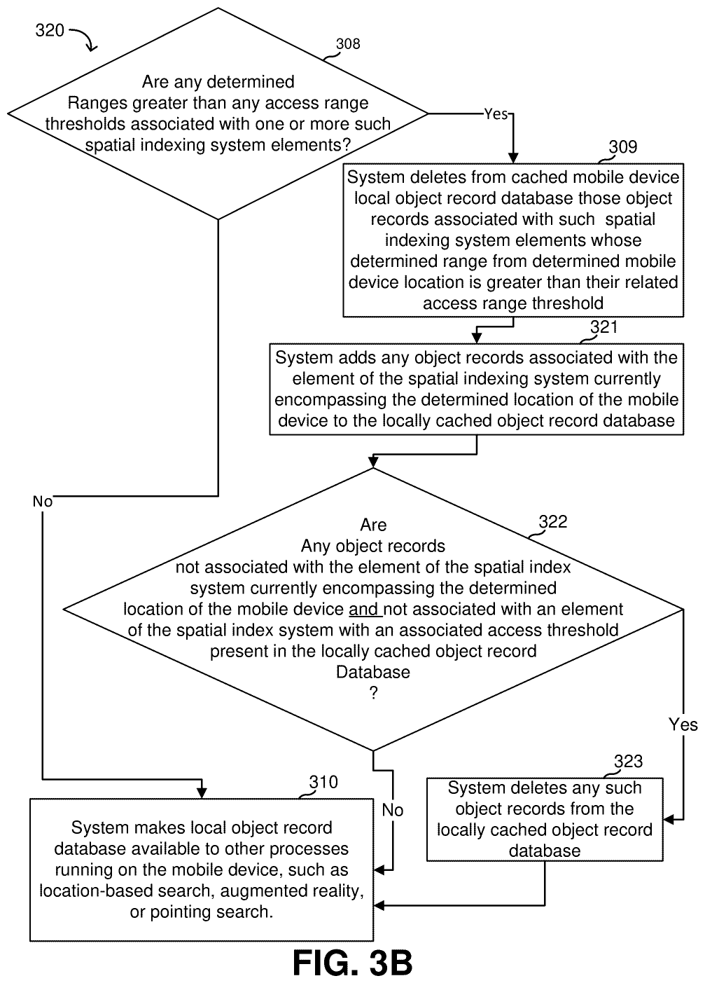

FIG. 3A and FIG. 3B are flowcharts 300 & 320 illustrating a possible more advanced mode of operation of the system in relation to individual elements of a geospatial indexing system with associated access ranges taking into account elements both with and without access range thresholds. As a non-limiting example, the location associated with the access range threshold for each element is shown as at the center of each element but this need not be true in all instances. The system might be a client device or other device mentioned herein. In step 301, the system determines the location of the mobile device and searches a database of elements of a geospatial indexing system using the determined location of the mobile device and an initial range threshold to determine a geographical search area and further determines those elements of the geospatial indexing system that are encompassed by the geographical search area. It should be noted that the term “encompassed by the geographical search area” may be taken to mean but is not limited to the entire geographical area defined by an individual element being encompassed by the search area, a portion of the geographical area defined by an individual element being encompassed by the search area, or a geographical location associated with that element being encompassed by the search area. This search using an initial range threshold will limit the number of elements to be considered by the system for future interrogation. For example, given an initial range threshold of 500 m, where the scale of each element of a hexagonal geospatial indexing system were hexagons 10 m across, the search would yield a result of approximately 750 elements available for future interrogation by the system. The flowchart then branches to step 302. In step 302, the system determines if one or more elements of the geospatial indexing system returned as a result in the search performed in step 301 has an associated access range threshold. If the system determines that one or more elements of the geospatial indexing system returned as a result in the search performed in step 301 does not have an associated access range threshold, the flowchart branches to step 301 to repeat the process. If the system determines that one or more elements of the geospatial indexing system returned as a result in the search performed in step 301 has an associated access range threshold, the flowchart branches to step 303. In step 303, the system determines if object records associated with those elements of the geospatial indexing system with related access range thresholds are already cached in the local object record database. If the system determines that those object records associated with those elements of the geospatial indexing system with related with related access range thresholds are already cached in the local object record database, the flowchart then branches to step 307. If the system determines that those object records associated with those elements of the geospatial indexing system with related access range thresholds are not already cached in the local object record database, the flowchart then branches to step 304.

In step 304, the system determines a range from the determined mobile device position to the location associated with each such element of the geospatial indexing system. The flowchart then branches to step 305. In step 305, the system determines if the determined range to the location associated with one or more such elements of the geospatial indexing system is less than the access range threshold associated with that element of the geospatial indexing system. If the determined range to the location associated with one or more such elements of the geospatial indexing system is not less than the access range threshold associated with that element of the geospatial indexing system, the flowchart then branches to step 307. If the determined range to the location associated with one or more such elements of the geospatial indexing system is less than the access range threshold associated with that element of the geospatial indexing system, the flowchart then branches to step 306.

In step 306, the system adds those object records associated with elements of the geospatial indexing system whose determined range is less than its associated access range threshold to the system's local object record database. The flowchart then branches to step 307. In step 307, the system determines the range from the determined location of the mobile device to the location of associated elements of the geospatial indexing system with object records cached in the system's local object record database. The flowchart then branches to step 308 of FIG. 3B. In step 308, the system compares any ranges, as determined in step 307 with access range thresholds associated with elements of the geospatial indexing system associated with each specific object record in the system's local object record database. If any such ranges are not greater than the access range thresholds associated with elements of the geospatial indexing system associated with each specific object record in the system's local object record database, then the flowchart branches to step 310. If any such ranges are greater than the associated access range thresholds elements of the geospatial indexing system associated with cach specific object record in the system's local object record database, then the flowchart branches to step 309.

In step 309, the system deletes from the system's local object record database those object records associated with those elements of the geospatial indexing system whose determined range from the determined location of the mobile device is greater than their associated range thresholds. The flowchart then branches to step 321.

In step 321 the system adds any object records associated with the element of the geospatial indexing system currently encompassing the determined location of the mobile device to the cached local object record database. In this way object records that are not associated with elements of the geospatial index system that have associated access range thresholds but are nearby would be added to the object record Geodescriptor database. While in this example only those object records associated with the element that the mobile device is currently located in are added alternate methodologies, such as adding all object records within the current element and all adjacent elements, etc., are not excluded. It should also be noted that this may result in duplicate object records being saved to the cached local object record Geodescriptor database but these may be dealt with in various ways including but not limited to eliminating any duplicates. The flowchart then branches to step 322.

In step 322 the system determines if any object records not associated with the element of the geospatial index system currently encompassing the determined location of the mobile device and not associated with an element of the geospatial index system with an associated access threshold are present in the cached local object record Geodescriptor Database. If such object records are present in the cached local object record Geodescriptor database the flowchart branches to step 323, in which such object records are deleted from the cached local object record Geodescriptor database, and then branches back to step 310 of FIG. 3A. If such object records are not present in the cached local object record Geodescriptor database the flowchart branches back to step 310 of FIG. 3A.

In step 310, the system makes the system's local object record database available to other processes, such as location-based search, augmented reality or pointing search, running on the mobile device. The flowchart then branches back to step 301 to continue the filtering process for the system's cached local object record database.

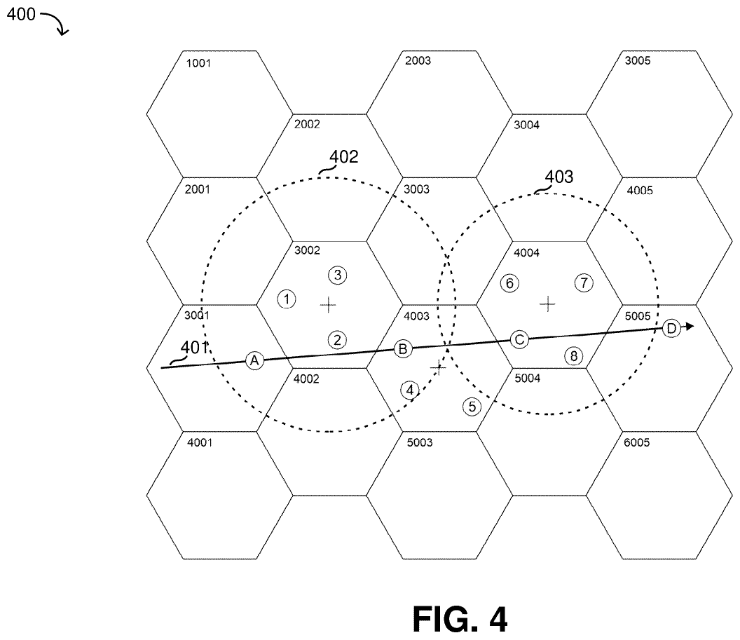

FIG. 4 is a diagram 400 illustrating, in plan view, an example of a possible mode of operation of the system associated with access range as described in FIG. 3A and FIG. 3B and related text. This example is simplified in that the initial range threshold used to define the search area in relation to the determined position of the mobile device encompasses all object records (1-8) present in this example. A mobile device is moving along a route 401 and is continually filtering its local cached object record database according to the method described in FIG. 3A and FIG. 3B and related text. While the route of travel taken by the mobile device is shown as a straight line for simplicity of explanation it should be appreciated that a non-linear route of travel is also possible with no alteration to underlying method. In this example, there are two elements of the geospatial indexing system, element 3002 and element 4004, with an associated access range threshold, 402 and 403, respectively. At determined location A the mobile device is within the access range threshold 402 associated with element 3002 and hence adds object records 1, 2 & 3 which are associated with element 3002 to the cached local object record Geodescriptor database. No object records are present in element 3001 (the element that encompasses location A). At determined location B the mobile device remains within the access range threshold 402 associated with element 3002 and is also encompassed by element 4003. Hence the system adds object records 4 & 5 which are associated with element 4003 to the cached local object record Geodescriptor database. Although element 4003 is not contained within the range thresholds 402 and 403, because the element is encompassed in the route of travel, object record 5 is nevertheless added to the local object record database. At determined location C the mobile device is now encompassed by element 4004, is also within the access range threshold 403 associated with element 4004, and is no longer within the access range 402 associated with element 3002. Hence the system adds object records 6, 7 & 8 which are associated with element 4004 to the cached local object record Geodescriptor database and deletes object records 1, 2 & 3 which are associated with element 3002 and object records 4 & 5 which are associated with element 4003 from the cached local object record Geodescriptor database. At determined location D the mobile device is no longer within the access range threshold associated 402 with element 4004 402 and is no longer encompassed by element 4004. For this example, the local cached database of geodescriptors would be as follows for each discrete mobile device location;

| | Object Records in Mobile Device |
|---|---|
| Mobile Device Location | Cached Object Record Database |
| A | 1, 2, 3 |
| B | 1, 2, 3, 4, 5 |
| C | 6, 7, 8 |
| D | — |

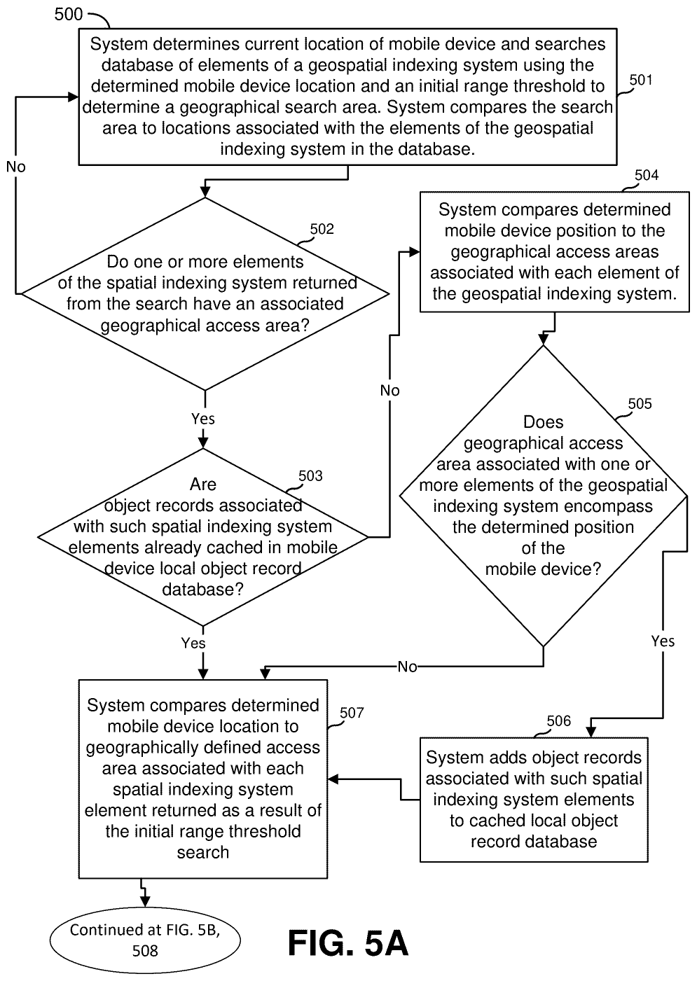

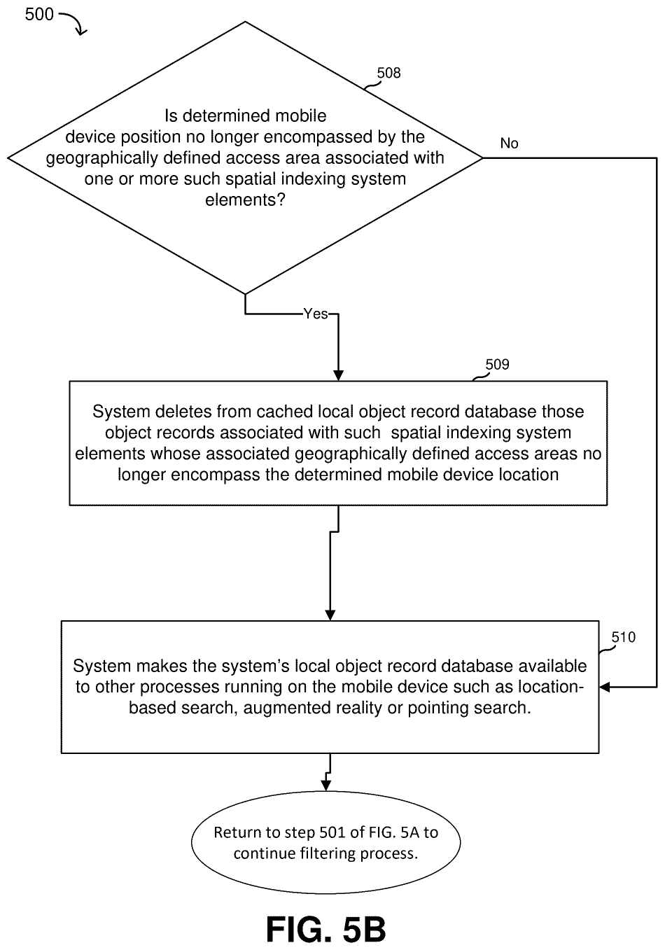

FIGS. 5A and 5B are a flowchart 500 illustrating a possible mode of operation of the system associated with the location of a mobile device in relation to various geographically defined access areas. In step 501, the system determines the location of a mobile device and searches a database of elements of a geospatial indexing system using a determined location of the mobile device and an initial range threshold to determine a geographical search area and comparing this search area to the locations associated with the elements of the geospatial indexing system in the database. The flowchart then branches to step 502. In step 502, the system determines if one or more elements of the geospatial indexing system returned as a result in the search performed in step 501 has an associated geographical access area. If the system determines that one or more elements of the geospatial indexing system returned as a result in the search performed in step 501 do not have an associated geographical access area the flowchart branches back to step 501 to repeat the process. If the system determines that one or more elements of the geospatial indexing system returned as a result in the search performed in step 501 has an associated geographical access area the flowchart branches to step 503.

In step 503, the system determines if object records associated with those elements of the geospatial indexing system with related geographical access areas are already cached in the local object record database. If the system determines that those object records associated with those elements of the geospatial indexing system with related geographical access areas are already cached in the local object record database, the flowchart then branches to step 507. If the system determines that those object records associated with those elements of the geospatial indexing system with related geographical access areas are not already cached in the local object record database, the flowchart then branches to step 504. In step 504, the system compares the determined mobile device position to the geographical access areas associated with each such element of the geospatial indexing system. The flowchart then branches to step 505. In step 505, the system determines if the geographical access area associated with one or more such element of the geospatial indexing system encompasses the determined position of the mobile device. If the determined location of the mobile device is not encompassed by the geographical access area associated with one or more such elements of the geospatial indexing system the flowchart then branches to step 507. If the determined location of the mobile device is encompassed by the geographical access area associated with one or more such elements of the geospatial indexing system the flowchart then branches to step 506.

In step 506, the system adds those object records associated with such elements of the geospatial indexing system whose related geographical access area encompasses the determined location of the mobile device to the system's local object record database cached on the mobile device. The flowchart then branches to step 507. In step 507, the system compares the determined location of the mobile device to the geographical access areas, if any, associated with such element of the geospatial indexing system with associated cached object records in the system's local object record database. The flowchart then branches to step 508. In step 508, the system determines if the geographical access areas associated with the elements of the geospatial indexing system with associated cached object records in the system's local object record database encompasses the determined location of the mobile device. If any such geographical access areas associated with each specific element of the geospatial indexing system with associated object records in the system's local object record database do not encompass the determined position of the mobile device, then the flowchart branches to step 509. If such geographical access areas associated with each specific element of the geospatial indexing system with associated object records in the system's local object record database do encompass the determined position of the mobile device, then the flowchart branches to step 510.

In step 509, the system deletes from the system's local object record database those object records associated with such elements of the geospatial indexing system whose geographical access areas do not encompass the determined location. The flowchart then branches to step 510. In step 510, the system makes the system's local object record database available to other processes, such as location-based search, augmented reality or pointing search, running on the mobile device. The flowchart then branches back to step 501 to continue the filtering process for the system's cached local object record database.

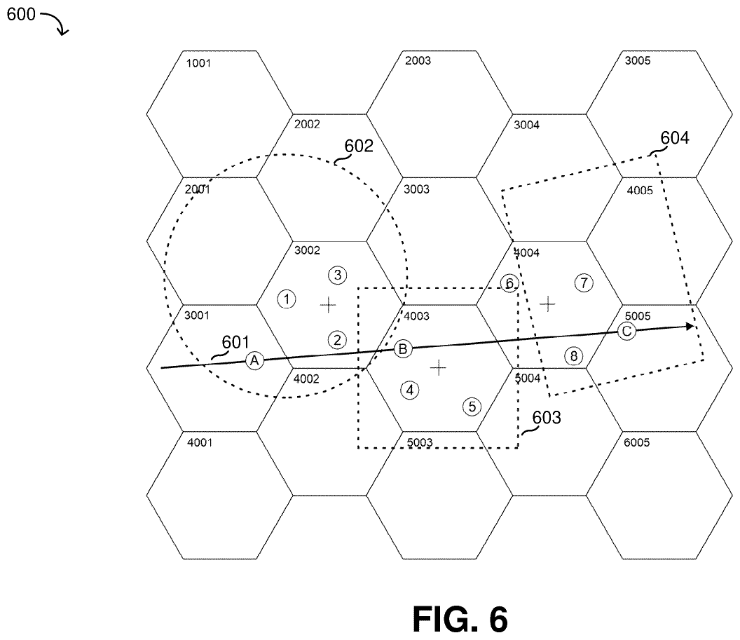

FIG. 6 is a diagram 600 illustrating, in plan view, an example of a possible mode of operation of the system associated with access areas as described in FIG. 5 and related text. This example is simplified in that the initial range threshold used to define the search area in relation to the determined position of the mobile device encompasses all object records (1-8) present in this example. A mobile device is moving along a route 601 and is continually filtering its local cached object record database according to the method described in FIG. 5 and related text. While the route of travel taken by the mobile device is shown as a straight line for simplicity of explanation it should be appreciated that a non-linear route of travel is also possible with no alteration to underlying method. In this example, there are three elements of the geospatial indexing system, element 3002, element 4003 and element 4004, with an associated access area, 602, 603 and 604 respectively. At determined location A the mobile device is within the access area 602 associated with element 3002 and hence adds object records 1, 2 & 3 which are associated with element 3002 to the cached local object record Geodescriptor database. It should be noted that while the access area 601 associated with element 3002 is circular it is not centered on element 3002. At determined location B the mobile device is no longer within the access area 602 associated with element 3002 and is encompassed by the access area 603 associated with element 4003. Hence the system deletes object records 1, 2 & 3, which are associated with element 3002, from the cached local object record Geodescriptor database and adds object records 4 & 5 which are associated with element 4003 to the cached local object record Geodescriptor database. It should be noted here that while the access area 603 associated with element 4003 is centered on element 4003 it is a polygon rather than a circle. At determined location C, the mobile device is no longer within the access area 603 associated with element 4003 and is now encompassed by the access area 604 associated with element 4004. Hence the system deletes object records 4 & 5, which are associated with element 4003, from the cached local object record Geodescriptor database and adds object records 6, 7 & 8 which are associated with element 4004 to the cached local object record Geodescriptor database. It should be noted here that the access area 604 associated with element 4004 is a rectangle not centered on element 4004 and with an alignment in relation to the local geographical coordinate system different to that of access area 603. It should also be noted that local access areas associated with elements of a geospatial indexing system may not encompass the area defined by the element at all. Thus, the access area might be entirely geographically independent from the area defined by the element of the geospatial indexing system. For this example, the local cached database of geodescriptors would be as follows for each discrete mobile device location:

| | Object Records in Mobile Device |
|---|---|
| Mobile Device Location | Cached Object Record Database |
| A | 1, 2, 3 |
| B | 4, 5 |
| C | 6, 7, 8 |

The methods described in FIGS. 1A & 1B, 3A & 3B, and 5A & 5B and associated text describe the adding or subtracting of object records from a local database of object records based upon access ranges or access areas associated with elements of a geospatial indexing system and are not intended to describe the initial generation or curation over time of the local object record database in its entirety. It should also be noted that the described methods could run in series or in parallel to filter a local cached database of object records for both access range and geographical access areas.

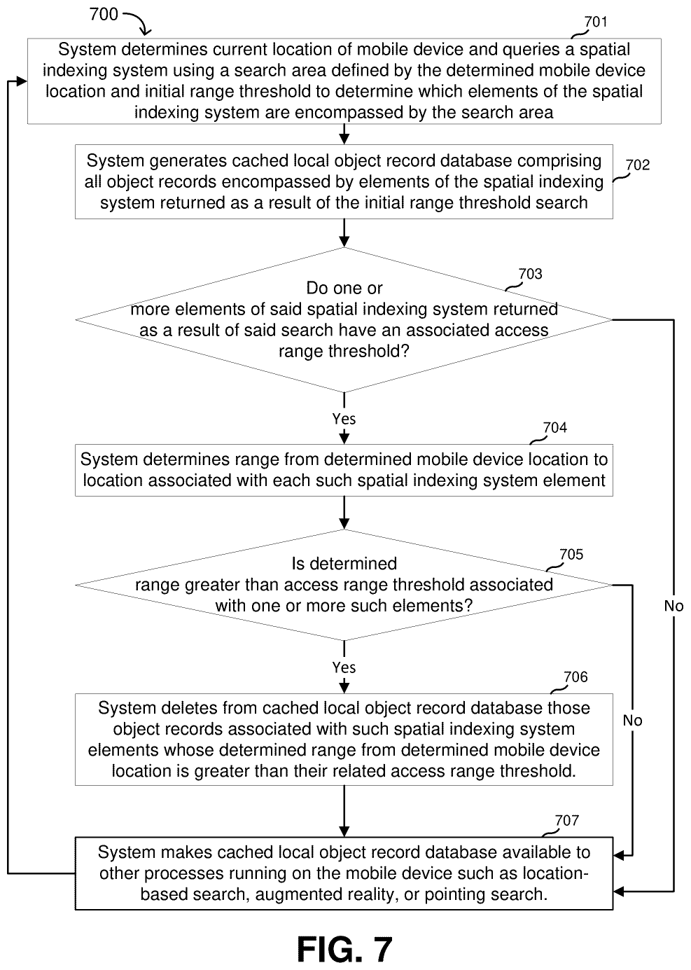

FIG. 7 is a flowchart 700 illustrating a possible mode of operation of the system associated with the location of a mobile device in relation to individual elements of a geospatial indexing system with associated access ranges. In step 701, the system determines the current location of mobile device and queries a spatial indexing system using a search area defined by the determined mobile device location and initial range threshold to determine which elements of the spatial indexing system are encompassed by the search area. The flowchart then branches to step 702. In step 702, the system generates a cached local object record database comprising all object records encompassed by elements of the spatial indexing system returned as a result of the initial range threshold search. The flowchart then branches to step 703. In step 703, the system determines if one or more of the elements of said spatial indexing system returned as a result of said search have an associated access range. If one or more of the elements of said spatial indexing system returned as a result of said search do not have an associated access range threshold the flowchart branches to step 707, in which the system makes the cached local object record database available to other processes running on the mobile device such as location-based search, augmented reality or pointing search, and then branches back to step 701 to continue the filtering of the cached local object record database. If one or more of the elements of said spatial indexing system returned as a result of said search do have an associated access range threshold the flowchart branches to step 704. In step 704, the system determines the range from determined mobile device location to the location associated with each such spatial indexing system element. The flowchart then branches to step 705. In step 705, the system determines if the determined range to each such element is greater than the access range threshold associated with one or more such elements. If the determined range to each such element is not greater than access range threshold associated with one or more such elements the flowchart branches to step 707. If the determined range to each such element is greater than the access range threshold associated with one or more such elements, the flowchart branches to step 706. In step 706 the system deletes from cached local object record database those object records associated with such spatial indexing system elements whose determined range from the determined mobile device location is greater than their related access range threshold. The flowchart then branches to step 707, in which the system makes the cached local object record database available to other processes running on the mobile device such as location-based search, augmented reality or pointing search, and then branches back to step 701 to continue the filtering of the cached local object record database.

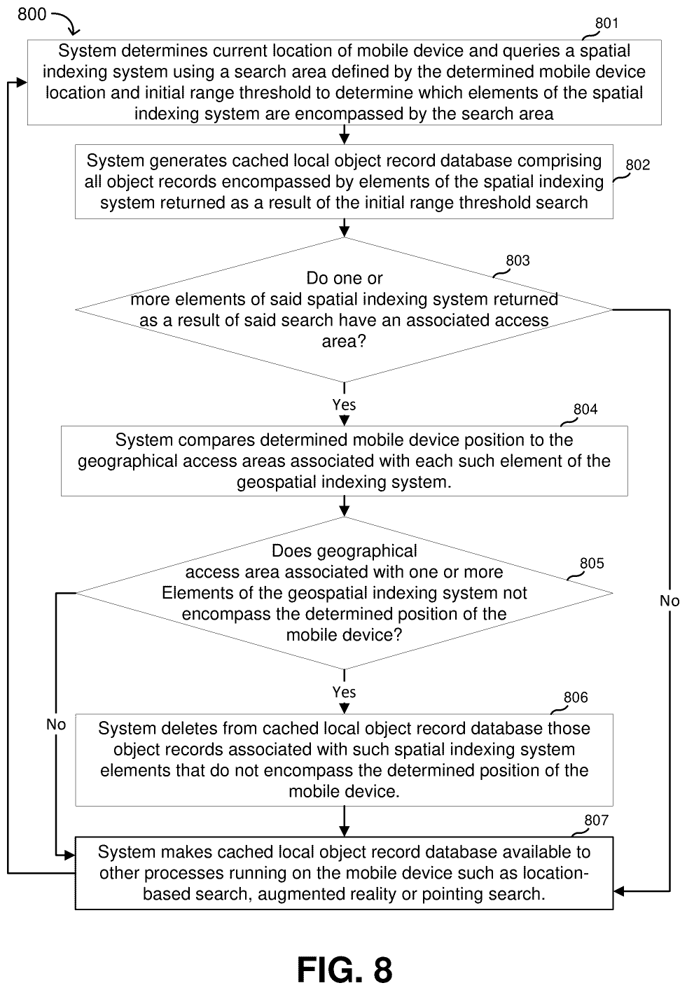

FIG. 8 is a flowchart 800 illustrating a possible mode of operation of the system associated with the location of a mobile device in relation to individual elements of a geospatial indexing system with associated geographical access areas. In step 801 the system determines the current location of mobile device and queries a spatial indexing system using a search area defined by the determined mobile device location and initial range threshold to determine which elements of the spatial indexing system are encompassed by the search area. The flowchart then branches to step 802. In step 802 the system generates a cached local object record database comprising all object records encompassed by elements of the spatial indexing system returned as a result of the initial range threshold search. The flowchart then branches to step 803. In step 803 the system determines if one or more of the elements of said spatial indexing system returned as a result of said search have one or more associated geographical access areas. If one or more of the elements of said spatial indexing system returned as a result of said search do not have an associated geographical access areas the flowchart branches to step 808, in which the system makes the cached local object record database available to other processes running on the mobile device such as location-based search, augmented reality or pointing search, and then branches back to step 801 to continue the filtering of the cached local object record database. If one or more of the elements of said spatial indexing system returned as a result of said search do have an associated geographical access areas, the flowchart branches to step 804. In step 804 the system compares the determined mobile device position to the geographical access areas associated with each such element of the geospatial indexing system. The flowchart then branches to step 805. In step 805 the system determines if the determined location of the mobile device is encompassed by one or more geographical access areas associated with one or more such elements. If the determined location of the mobile device is not encompassed by one or more geographical access areas associated with one or more such elements 808. If the determined location of the mobile device is encompassed by one or more geographical access areas associated with one or more such elements the flowchart branches to step 806. In step 806 the system deletes from cached local object record database those object records associated with such spatial indexing system elements whose determined geographical access area encompass the determined mobile device location. The flowchart then branches to step 808, in which the system makes the cached local object record database available to other processes running on the mobile device such as location-based search, augmented reality or pointing search, and then branches back to step 801 to continue the filtering of the cached local object record database.

In some embodiments, a more advanced variation of the implementation of the concepts relating to access ranges and access threshold associated with elements of a spatial indexing system as described above is possible. Object records associated with such elements of a spatial indexing system may be added to or removed from the cached local object record database using the methods described above but individual object records may be treated differently in various ways according to pre-set rules associated with individual object records.

Object records in such elements may be excluded from being added to or removed from the cached local object record database, such that associated with an object record may be a rule stating an opt-out from the access range or access area of the element the objects are encompassed by. In the cases when the determined mobile device location is beyond the access range or outside the access area associated with an individual element the system would have to perform the additional step of determining if any object records were excluded from the rules related to access range or access area associated with that element and therefore should be included in the cached local object record database even if the other object records associated with that element should be excluded/removed from the cached local object record database. A practical use of such a system in regards to access area may be that of a shopping mall whose geographical footprint is encompassed, or partially encompassed, by an element of the spatial indexing system. A mall may have many individual shops, etc. within it and hence may contain many individual object records. If the determined location of the mobile device of a user of the system was outside the access area associated with the element that encompassed the footprint of the mall, they would not be overwhelmed by the multitude of object records within the footprint of the mall. In some embodiments, those object records would be excluded from the local cached object record database, but the object record that identifies the mall as a whole may have an associated access range opt-out rule and therefore the object record for the mall as a whole would be included in the cached local object record database.

Object records in such elements may have an associated rule that is a modifier to the access range of the element they are encompassed by. This modifier may increase or decrease the access range associated with such an object record in relation to the default access range of the element which encompasses it by a percentage, add or subtract a defined distance from the default access range of the element which encompasses it, or be a pre-set access range that is different from the default access range of the element which encompasses it. In the cases when the determined mobile device location is beyond the access range associated with an individual element the system would have to perform the additional step of determining if any object records associated with that element have associated rules related to access range and, if so, should they be included in the cached local object record database even if the other object records associated with that element should be excluded/removed from the cached local object record database. For example, if an element has an associated default access range of 100 m but also encompasses an object record (“object A”) with an access range modifier of +50% (such that object A and only object A has an access range threshold of 150 m) and the determined location of the mobile device is 125 m from the element, then all object records associated with that element other than object A's object record would be excluded from the cached local object record database.

Object records in such elements may have an associated rule that is a modifier to, or entirely replaces, the default access area of the element they are encompassed by. This modifier may increase, decrease, or scale the access area associated with such an object record in relation to the default access area of the element which encompasses it. The modification may be a percentage change, or be an access area that completely different from the default access area of the element which encompasses it. In the case of a new access area associated with such an object record the location of the geographical point that the access area is associated with may be that of the element of the geospatial indexing system or may be associated with the specific location of that individual object record. In the cases when the determined mobile device location is outside the access area associated with an individual element the system would have to perform the additional step of determining if any object records associated with that element have associated rules related to access area and, if so, should they be included in the cached local object record database even if the other object records associated with that element should be excluded/removed from the cached local object record database. For example, if an element has an associated default access area defined as a square 50 m across associated with the center of the element but also encompasses an object record (“object A”) with an access area defined as a circle of radius 70 m centered on the geographical location of object A and the determined location of the mobile device is outside the 50 m square access area associated with the element but inside the 70 m circular access are associated specifically with object A then all object records associated with that element other than object A's object record would be excluded from the cached local object record database.

Variability of access range and geographical access area (herein collectively known as the “access characteristics”) might be considered. The access characteristics associated with an element of a geospatial indexing system may be variable in relation to various parameters. Some examples might be:
Time of day, e.g., day/night. For example, an access range relating to a billboard object record may be 500 meters during daylight hours but is reduced by 50% to 250 meters during the evening hours.
Time of year/specific dates, e.g., the access range associated with a specific type of object record may be increased by 50% during a specific range of dates, e.g., a commerce-type object record may have its access range increased during the holiday period of December 15th though January 2nd.
Local weather. For example, an access range associated with an object record may be reduced by 25% if it is raining at that location.
Ambient light levels. For example, the access range associated with an object record may be reduced by 75% if the local ambient light is below a defined threshold, e.g., it is getting darker at that location. The ambient light level need not be dependent on time of day. Light levels may be affected by other factors, such as heavy cloud cover.
Time to get to object record from determined location exceeds a pre-set time threshold. While an object record may be in range, the time for the user to transit from their current location to the location of the object record may be prohibitive. This would also be dependent on the current mode of travel of the user (walking, driving, public transport, etc.).
User indication of interest. For example, if a user has indicated that they are interested in ATMs, consequently object records that are identified as ATMs would have their access range increased by 50% or some other percentage.
Intervening terrain or other geographically-defined areas. For example, if a river is between the determined position of the mobile device and an element of a geospatial indexing system (the vector from the determined position of the mobile device to the an element of a geospatial indexing system crosses the geographical area that defines the river) and the access range for that an element of a geospatial indexing system is consequently reduced by 100% and hence it will not be added to cached database since it would be inaccessible to the user even if it was within range. Other types of blocking “terrain” might include roads/freeways, international borders, restricted/secure areas, or routes, etc.

Variability of access characteristics may be a 1) simple yes/no-availability depending on different criteria, or 2) reduced or increased by a percentage of the original (e.g., 50%, 30%, 140%, etc.).

The number of the various access characteristics associated with an element of a geospatial indexing system may also be variable depending on various criteria.

While the examples of the system in operation described above show each element of a geospatial indexing system having a single access range or access area with it, it may also be true that a single element of a geospatial indexing system may have more than one of each type associated with it.

### AI Augmentation

Algorithms including but not limited to machine learning systems known collectively as Artificial intelligence (AI) may constantly update the cached local object record database based upon local actions taken by the current user of the system or other users over time or other crowd-sourced data. An AI program may also add additional object records to the cached local object record database based upon learned user preference (either the current user of the system, other users of the system, or a combination) or other crowd-sourced data. Additionally, by predicting those object records in the cached local object record database that are most likely to be accessed by a user of the system an AI program may start to add information/detail to those object records to enable more rapid access by the user of that information or detail if the user accesses that object record. Such additions to the cached local object record database may be limited to those object records encompassed by those Geospatial indexing system cells currently adjacent to cell that currently encompasses determined location of mobile device (or out to 2nd, 3rd, etc. additional layers) or be limited to those Geospatial indexing system cells available to the system according the access range and access area methods described previously. Removing the object records added to the cached local object record database may also follow the methods described previously.

For example, a object record for an ice-cream shop has been added to the users cached local object record database. The AI has noted that this is a highly rated establishment according to available crowd-sourced data and additionally this establishment has been accessed a majority of the time when added to other users cached local object record databases. Hence the AI will begin adding additional information to that cashed object record such as the menu etc. In a different example the AI may have discovered that a clothing store currently in the cached local object record database is having a flash 15% off sale for the next 30 minutes (such information not being part of the standard object record dataset since it is time sensitive) and adds this information to that object record.

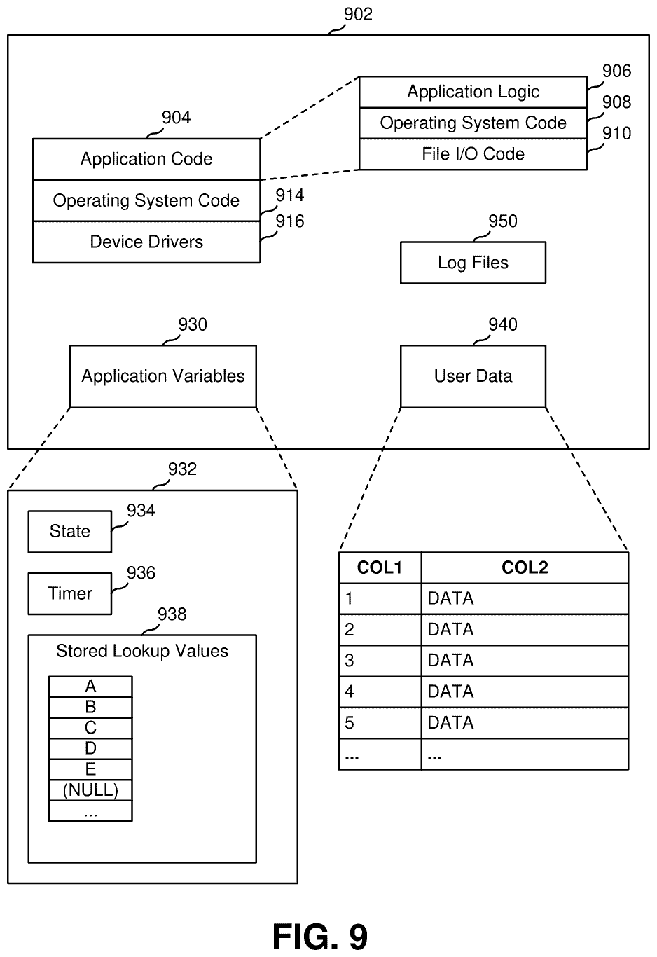

FIG. 9 is a simplified functional block diagram of a storage device 902 having an application that can be accessed and executed by a processor in a computer system as might be part of embodiments of the system described herein and/or a computer system that performs operations described herein. FIG. 7 also illustrates an example of memory elements that might be used by a processor to implement elements of the embodiments described herein. In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 902 can be one or more memory device that can be accessed by a processor and storage device 902 can have stored thereon application code 904 that can be one or more processor readable instructions, in the form of write-only memory and/or writable memory. Application code 904 can include application logic 906, library functions 908, and file I/O functions code 910 associated with the application. The memory elements of FIG. 7 might be used for a server or computer that interfaces with a user, generates data, and/or manages other aspects of a process described herein. In addition to application code 904, storage device 902 might also contain operating system code 914 and device drivers 916.

Storage device 902 can also include storage for application variables 930 that can include one or more storage locations configured to receive variables 932. Application variables 930 can include variables that are generated by the application or otherwise local to the application, such as state variables 934, timers 936, and/or stored lookup values 938. Application variables 930 can be generated, for example, from data retrieved from an external source, such as a user or an external device or application. A processor can execute application code 904 to generate application variables 930 provided to storage device 902. Application variables 930 might include operational details needed to perform the functions described herein.

Storage device 902 can include storage for databases and other data described herein. One or more memory locations can be configured to store user data 940, which might include data sourced by an external source, such as a user or an external device. User data 940 can include, for example, records being passed between servers prior to being transmitted or after being received. Other data might also be supplied.

Storage device 902 can also include log files 950 having one or more storage locations configured to store results of the application or inputs provided to the application. For example, log files 950 can be configured to store a history of actions, alerts, error messages, and the like.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

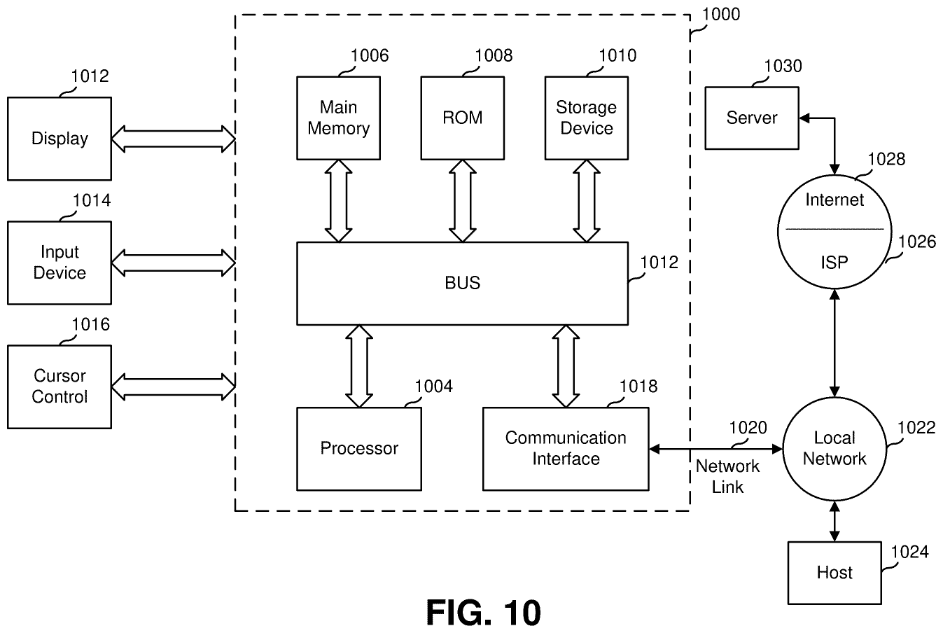

FIG. 10 is a block diagram that illustrates a computer system 1000 upon which the computer systems of the systems described herein and/or data structures shown in FIG. 9 may be implemented. Computer system 1000 includes a bus 1002 or other communication mechanism for communicating information, and a processor 1004 coupled with bus 1002 for processing information. Processor 1004 may be, for example, a general-purpose microprocessor.

Computer system 1000 also includes a main memory 1006, such as a random-access memory (RAM) or other dynamic storage device, coupled to bus 1002 for storing information and instructions to be executed by processor 1004. Main memory 1006 may also be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a computer monitor, for displaying information to a computer user. An input device 1014, including alphanumeric and other keys, is coupled to bus 1002 for communicating information and command selections to processor 1004. Another type of user input device is a cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware, and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a network connection. A modem or network interface local to computer system 1000 can receive the data. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be a network card, a modem, a cable modem, or a satellite modem to provide a data communication connection to a corresponding type of telephone line or communications line. Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world-wide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020, and communication interface 1018. In the Internet example, a server 1030 might transmit a requested code for an application program through the Internet 1028, ISP 1026, local network 1022, and communication interface 1018. The received code may be executed by processor 1004 as it is received, and/or stored in storage device 1010, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided by a transitory computer readable medium, e.g., a transmission medium, such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets:

{A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method for populating a local object records database, wherein an object record in the local object records database represents information about an object to which the object record is associated, and the object having a geolocation represented in the object record, the method comprising:
determining a device geolocation state of a mobile device, wherein the device geolocation state corresponds at least to a device geolocation of the mobile device;
determining a first geographical search area as a function of at least the device geolocation and a pre-determined range threshold relative to the device geolocation;
querying a geospatial indexing system database, wherein the geospatial indexing system database comprises a plurality of elements, and wherein each element of the geospatial indexing system has a corresponding geolocation that is within the first geographical search area;
obtaining a result set of object records encompassed by the elements of the geospatial indexing system corresponding to the first geographical search area in response to the querying;
populating the local object records database with the result set;
determining whether the result set comprises filterable object records, wherein an object record is a filterable object record if the object record includes a filter parameter;
comparing, for at least one filterable object record, if one exists in the result set, the filter parameter, and the device geolocation state; and
if the at least one filterable object record is present in the result set and the filter parameter does not match the device geolocation state, filtering the at least one filterable object record from the local object records database.

2. The method of claim 1, wherein the device geolocation state corresponds at least to the geolocation of the mobile device and/or an orientation direction of the mobile device.

3. The method of claim 1, wherein the first geographical search area comprises a two-dimensional representation of a point or area on a surface of Earth.

4. The method of claim 1, wherein at least one of the filterable object records includes a plurality of filter parameters.

5. The method of claim 1, wherein comparing the filter parameter and the device geolocation state comprises determining whether the device geolocation state matches within each constraint specified by the filter parameter.

6. The method of claim 5, wherein the constraint specified by the filter parameter of the at least one filterable object record is that a device-object distance determined between the device geolocation and the corresponding geolocation of the object represented by the at least one filterable object record is less than or equal to some maximum device-object distance.

7. The method of claim 5, wherein the constraint specified by the filter parameter of the at least one filterable object record is that the device geolocation is within one or more elements of the geospatial indexing system.

8. The method of claim 7, wherein an element of the geospatial indexing system is represented by a polygonal shape.

9. The method of claim 8, wherein an element of the geospatial indexing system is represented by a hexagonal shape.

10. The method of claim 5, wherein the constraint specified by the filter parameter of the at least one filterable object record further constrains the object represented by the at least one filterable object record to have a corresponding geolocation within a limited range of angles around the object represented by the at least one filterable object record defined by an object access angle range, wherein if any portion of an element falls within the limited range of angles or a defined threshold, all object records associated with that element are included in the search result.

11. The method of claim 1, wherein filtering the at least one filterable object record from the local database comprises deleting the at least one filterable object record from the local database.

12. The method of claim 1, wherein filtering the at least one filterable object record from the local database comprises masking the at least one filterable object record to filter the at least one filterable object record from a subsequent local retrieval of object records.

13. The method of claim 1, wherein the filter parameter represents one or more of an access range limit, a geographically-defined closed area, and/or an object access angle range.

14. A non-transitory computer-readable storage medium storing instructions, which when executed by at least one processor of a computer system, causes the computer system to populate a local object records database wherein an object record in the local object records database represents information about an object to which the object record is associated, and the object having a geolocation represented in the object record,, the instructions comprising instructions for:
determining a device geolocation state of a mobile device, wherein the device geolocation state corresponds at least to a device geolocation of the mobile device;
determining a first geographical search areas a function of at least the device geolocation and a pre-determined range threshold relative to the device geolocation;
querying a geospatial indexing system database, wherein the geospatial indexing system database comprises a plurality of elements, and wherein each element of the geospatial indexing system has a corresponding geolocation that is within the first geographical search area;
obtaining a result set of object records encompassed by the elements of the geospatial indexing system corresponding to the first geographical search area in response to the querying;
populating the local database with the result set;
determining whether the result set comprises filterable object records, wherein an object record is a filterable object record if the object record includes a filter parameter;
comparing, for at least one filterable object record, where one exists in the result set, the filter parameter, and the device geolocation state; and
if the at least one filterable object record is present in the result set and the filter parameter does not match the device geolocation state, filtering the at least one filterable object record from the local object records database.

15. The non-transitory computer-readable storage medium of claim 14, wherein the device geolocation state corresponds at least to the geolocation of the mobile device and/or an orientation direction of the mobile device.

16. The non-transitory computer-readable storage medium of claim 14, wherein comparing the filter parameter and the device geolocation state comprises determining whether the device geolocation state matches within each constraint specified by the filter parameter.

17. The non-transitory computer-readable storage medium of claim 14, wherein an element of the geospatial indexing system is represented by a polygonal shape.

18. The non-transitory computer-readable storage medium of claim 14, wherein an element of the geospatial indexing system is represented by a hexagonal shape.

19. The non-transitory computer-readable storage medium of claim 14, wherein the filter parameter represents one or more of an access range limit, a geographically-defined closed area, and/or an object access angle range.

20. The non-transitory computer-readable storage medium of claim 14, wherein the constraint specified by the filter parameter of the at least one filterable object record further constrains the object represented by the at least one filterable object record to have a corresponding geolocation within a limited range of angles around the object represented by the at least one filterable object record defined by an object access angle range, wherein if any portion of an element n falls within the limited range of angles or a defined threshold, all object records associated with that element are included in the search result.
